(19) United States
(12) Patent Application Publication
(10) Pub. No.: US 2013/0077965 A1
(43) Pub. Date: Mar. 28, 2013

(54) METHOD AND APPARATUS FOR OPTICALLY OUTPUTTING INFORMATION FROM A SEMICONDUCTOR DEVICE

(71) Applicants: Konstantin Nikolic, London (GB); Timothy Constandinou, London (GB); Christofer Toumazou, London (GB)

(72) Inventors: Konstantin Nikolic, London (GB); Timothy Constandinou, London (GB); Christofer Toumazou, London (GB)

(73) Assignee: IMPERIAL INNOVATIONS LIMITED, London (GB)

(21) Appl. No.: 13/576,216

(22) PCT Filed: Feb. 1, 2011
(86) PCT No.: PCT/GB2011/000132

§ 371 Date: Dec. 4, 2012

(30) Foreign Application Priority Data
Feb. 2, 2010 (GB) 1001696.2
Nov. 10, 2010 (GB) 1019016.3

(51) Int. Cl. H04B 10/08

(52) U.S. Cl. CPC H04B 10/501
USPC 398/38

(57) ABSTRACT

A method of optically outputting information (e.g. digital data) from a semiconductor device, the method comprising: providing a semiconductor device having a semiconducting p-n junction, the p-n junction having a region of reduced free charge carrier density; applying an electrical signal to modulate the extent of the said region, the electrical signal being representative of the information to be outputted; arranging incident light to pass through at least part of the said region, such that the light is at least partially absorbed in dependence upon the modulated extent of the said region, thereby producing intensity-modulated output light; and detecting the intensity of the output light and thereby determining the outputted information. Also provided is an electro-optical assembly, a package module for mounting a semiconductor device on a printed circuit board, and an integrated circuit chip.

This invention relates to a method and apparatus for optically outputting information from a semiconductor device. It is particularly suitable for, but by no means limited to, the transmission of digital data for communications/telecommunications applications. Other potential applications are envisaged in situations in which it would be difficult, impossible or undesirable to provide an electrical data connection from a semiconductor device.

### BACKGROUND TO THE INVENTION

With the advent of modern telecommunications, the integration of microelectronics with optical components has become increasingly desirable. Typically systems utilising optical components are fabricated using specialist technologies, and are consequently fabricated separately from the integrated circuits (microelectronics) and later combined at board-level. Both the use of custom technology and the need for board-level integration give rise to an increased cost. Monolithic integration of optical components and integrated circuits is therefore a key driver in the emerging field known as silicon photonics. However, the vast majority of such “optoelectronic integrated circuits” also require specialist semiconductor fabrication technologies or additional process steps to integrate both the optical and electronic components, which are not yet mainstream. The development of a method to output information from a semiconductor device or a chip using light within a low cost integrated technology is therefore of great interest to the industry.

In this respect, complementary metal oxide semiconductor (CMOS) technology, based on bulk-silicon, is well established, and CMOS devices can be fabricated with economies of scale. However, to date, CMOS technology has not provided a way of emitting light to transmit data without using some special fabrication processes, as silicon is an indirect bandgap material and is consequently not a good material from which to fabricate a light emitter. Without the ability to emit light, it has not been possible to output data optically (i.e. data encoded in light) from a CMOS device. There is a desire to overcome this problem and achieve the ability to output data, optically, from a CMOS device manufactured using standard (commercially available) CMOS technology and integrated circuits (ICs).

Additionally, in previous CMOS Application Specific Integrated Circuit (ASIC) devices, which input and output data electrically, the ASIC normally has bond pads arranged around its periphery. These bond pads are areas of metallisation which are large enough for a bond wire (usually gold) to be connected to them, and are connected to an input and/or output buffer. They therefore have a relatively large capacitance, which can slow down the signals passing through them. In such previous ASIC devices, an input buffer chain (typically consisting of at least one CMOS inverter, arranged in a serial chain if there are more than one, and each of a successively decreased size, progressing from the package pin to the ASIC interior) connects the input signal from the package pin to the interior of the ASIC. Input electrostatic discharge (ESD) protection circuitry (such as reverse-biased diodes between the input, and each of power and ground), is usually necessary to guard the ASIC against very high voltages, such as static electricity, which could otherwise destroy the ASIC internals, but adds capacitative load to the bond pad, resulting in a delay to the input signal. The input buffer usually introduces a time delay (called a propagation delay) between an input signal applied at the package pin and the input signal at the ASIC core. Such a delay is undesirable and is to be kept as small as possible in many circumstances.

Moreover, in previous CMOS ASIC devices, each ASIC output is typically connected to a package pin via an output buffer (typically consisting of at least one CMOS inverter, arranged in a series chain if there are more than one, each of a successively increased size, progressing from the ASIC interior to the package pin). The output buffer has to be strong enough/large enough to drive the load of the package pin and any connected circuit trace, for example when mounted on a printed circuit board. Each successive buffer adds a propagation delay, which is generally undesirable and is to be kept as small as possible. Output buffers may also require electrostatic discharge (ESD) protection circuitry, resulting in increased capacitive load and thereby increased delay in the output signal.

Therefore, in view of the above-mentioned problems with existing electrical interconnection, optical interfacing would be desirable, but to date this has not been possible using standard CMOS semiconductor processes.

Furthermore, currently, CMOS dies (or chips), without the ability to communicate optically, normally have to be mounted and connected into a device package, the package being suitable for mounting on a printed circuit board (PCB). This is normally necessary because the small feature sizes on a CMOS die are normally too small to connect directly to circuit tracks on a PCB, and the metals used for interconnections on a CMOS die are often incompatible with solder used to join components to PCB circuit tracks. CMOS dies are therefore normally mounted into a package which has a plurality of interconnecting contacts, and each CMOS die interconnecting point is connected to the corresponding package connection with a wire bond. In previous packaged ASIC devices, the package pins are normally connected to the bond pads of the ASIC by very thin wires, called bond wires, which are typically made of a malleable conductive material such as gold. Each wire is connected (i.e. welded) to a bond pad on the CMOS die and to a connection area inside a recess (i.e. cavity) of the package. The connected CMOS die is then normally encapsulated inside the package to protect it from damage. Reliability problems sometimes result from failure of the welded joint between the bond pads and the bond wires.

Finally, the process of customizing chip packages to match the design of a CMOS die requires special techniques and skill, and is accessible only to large chip design enterprises. Therefore a way of avoiding the need to design specialised chip packages is desirable. Furthermore, in the future multi-core microprocessor architectures, favoured now by all major microprocessor manufacturers, optical interconnects instead of electrical probably will be needed if the number of cores approaches 100 and above. Issues such as scalability and power dissipation will impede effective electrical interconnections in such a case. Optical interconnects would allow easier transition to full 3D chip architectures.

Thus, in summary, there are numerous disadvantages associated with the existing requirement that data be outputted electrically, rather than optically, from CMOS devices.

### SUMMARY OF THE INVENTION

According to a first aspect of the present invention there is provided a method as defined in claim 1 of the appended claims. Thus there is provided a method of optically outputting information (e.g. digital data) from a semiconductor device, the method comprising: providing a semiconductor device having a semiconducting p-n junction, the p-n junction having a region of reduced free charge carrier density; applying an electrical signal to modulate the extent of the said region, the electrical signal being representative of the information to be outputted; arranging incident light to pass through at least part of the said region, such that the light is at least partially absorbed in dependence upon the modulated extent of the said region, thereby producing intensity-modulated output light; and detecting the intensity of the output light and thereby determining the outputted information.

This enables an external light source (e.g. an LED, laser or laser-diode, or the tip of an optical fibre coupled to an LED, laser or laser-diode) to be used to directly extract data optically from a semiconductor device, which may be made, for example, from silicon using standard (commercially available) CMOS technology. The method is based on an electro-optical modulation, which utilises the free-carrier absorption.

The term “light” as used herein should be interpreted broadly, to encompass electromagnetic radiation of wavelengths outside the visible range (in particular, infra-red).

It is to be understood throughout that the p-n junction may be one of multiple such junctions (e.g. arranged as an array), which may be incorporated together in an integrated circuit. Moreover, vertical and/or lateral junction(s) may be utilised, as those skilled in the art will appreciate.

Preferable, optional, features are defined in the dependent claims.

Thus, preferably the incident light has a photon energy less than the bandgap of the semiconductor material. This makes the semiconductor material substantially transparent to the incident light.

Preferably the arranging step further comprises positioning a light source adjacent to the semiconductor device. The light source is preferably an LED, laser or laser-diode, or the tip of an optical fibre coupled to an LED, laser or laser-diode, although those skilled in the art will appreciate that other types of light source may also be suitable.

Preferably the light source supplies incident light of a substantially constant intensity. This facilitates the detection of changes in intensity in the output light, and thus facilitates the extraction of data from the output light.

Preferably the semiconductor device is silicon-based. In our particularly preferred embodiments the semiconductor device is a CMOS device.

Preferably the incident light has a wavelength greater than about 1 μm, since silicon is substantially transparent to infra-red radiation at such wavelengths. Indeed, a wavelength of about 1.55 μm, which is the peak wavelength of commercial readily-available infra-red emitters, may be used to good effect. The use of longer wavelengths (up to 8 μm in silicon) makes the effect and the signal-to-noise ratio even better.

In certain embodiments, the method may further comprise providing the semiconductor device with a reflective layer (e.g. a metallic film) positioned such that the incident light is reflected off the reflective layer after having passed through the said region, thus causing the light to pass back through the said region before being outputted. By passing the light through the said region twice, in this manner, this doubles the absorption effect resulting from the electrical modulation of the extent of the said region. Furthermore, this realisation allows for the light source and the light detector to be on the same side (under the substrate), freeing the top chip surface for possible postprocessing, e.g. for mounting additional sensors, microfluidic devices or complete lab-on-chip systems.

For such embodiments, the method may further comprise providing the semiconductor device with an insulating layer between the p-n junction and the reflective layer. This prevents the reflective layer (if metallic) from shorting the p-n junction.

In alternative embodiments, the incident light may be transmitted through the said region such that the output light continues in substantially the same direction as the incident light. This removes the need for a reflective layer and consequently may simplify the device architecture.

Preferably the electrical signal is configured to reverse bias the p-n junction.

Preferably the method further comprises positioning a photodetector adjacent to the p-n junction. To derive the changes in intensity of the output light, the detecting step may further comprise comparing the intensity of the output light with a reference intensity. As those skilled in the art will appreciate, the reference intensity may be a substantially constant level. Alternatively, the reference intensity may be derived from the intensity of the incident light, which is beneficial if the incident light is not of uniform intensity.

In certain embodiments the method may further comprise supplying data optically to the semiconductor device, and/or supplying power wirelessly to the semiconductor device. By such non-galvanic communication, such embodiments are ideally suited for applications requiring electrical isolation, e.g. “lab-on-chip” readouts. Accordingly, CMOS chips are now able to achieve both power and data transfer without any bond wires.

In certain embodiments the electrical signal may comprise a carrier frequency, the carrier frequency being amplitude modulated with a data signal. Moreover, the method may further comprise processing the detected intensity of the output light using a phase-lock technique. For example, the phase-lock technique may lock in to a second harmonic 2f; where f is the said carrier frequency. This may be advantageous in the event that the fundamental component of the output signal is hard to detect due to noise, but the second harmonic is still able to be detected.

According to a second aspect of the present invention there is provided an electro-optical assembly comprising: a semiconductor device having a semiconducting p-n junction, the p-n junction having a region of reduced free charge carrier density; electrical means arranged to apply an electrical signal to modulate the extent of the said region, the electrical signal being representative of information to be outputted from the semiconductor device; a light source arranged to provide incident light to pass through at least part of the said region, such that the light is at least partially absorbed in dependence upon the modulated extent of the said region, thereby producing intensity-modulated output light; and a detector arranged to detect the intensity of the output light and thereby determine the outputted information.

According to a third aspect of the present invention there is provided a package module for mounting a semiconductor device on a printed circuit board, the package module comprising: means for receiving a semiconductor device, the semiconductor device having a semiconducting p-n junction, the p-n junction having a region of reduced free charge carrier density; a light source arranged to provide incident light to pass through at least part of the said region in use, thereby producing output light; a detector arranged to detect the intensity of the output light and to produce an electrical output signal in dependence on said intensity; and an output connection for electrically connecting the package module to a printed circuit board, the output connection being driven, in use, in dependence on the said output signal.

To achieve non-galvanic communication between the package module and the semiconductor device, as mentioned above, the package module may further comprise means for transmitting data optically to the semiconductor device, and/or means for transmitting power wirelessly to the semiconductor device.

According to a fourth aspect of the present invention there is provided an integrated circuit chip comprising: a semiconductor device having a semiconducting p-n junction, the p-n junction having a region of reduced free charge carrier density; and electrical means operable in use to apply an electrical signal to modulate the extent of the said region, the electrical signal being representative of information to be outputted from the semiconductor device; wherein, in use, the said region is accessible by incident light, such that the incident light is able to pass through at least part of the said region, the light being at least partially absorbed in dependence upon the modulated extent of the said region, thereby producing intensity-modulated output light.

In certain embodiments the chip may further comprise a reflective layer positioned such that, in use, the incident light is reflected off the reflective layer after having passed through the said region, thus causing the light to pass back through the said region before being outputted. An insulating layer may also be provided between the p-n junction and the reflective layer.

Preferably the p-n junction is a parasitic diode, and preferably the electrical signal is configured to reverse bias the p-n junction.

To achieve non-galvanic communication with the chip, as mentioned above, the chip may further comprising means for receiving data optically, and/or means for receiving power wirelessly.

With all the aspects of the invention, preferable, optional, features are defined in the dependent claims.

### BRIEF DESCRIPTION OF THE DRAWINGS

Embodiments of the invention will now be described, by way of example only, and with reference to the drawings in which:

FIG. 1 comprises a series of plots showing (a) light refraction and (b) light absorption in c-Si at λ=1.55 μm as a function of free-carrier concentration replotted from [1], and (c) a doping profile through an n-channel metal oxide semiconductor (NMOS) device in a typical 0.18 μm CMOS technology;

FIG. 2 illustrates a cross-section of an embodiment of the invention, showing the incident and reflected paths of infra-red radiation through a silicon CMOS die;

FIG. 3 illustrates an integrated circuit package module for mounting a CMOS Application Specific Integrated Circuit (ASIC) die on a printed circuit board, the package module and the die each having an optical data/power communication unit for optically communicating with each other;

FIG. 4 illustrates a CMOS ASIC die, having an optical data/power communication unit for communicating with a corresponding optical data/power communication unit of an integrated circuit package module;

FIG. 5 illustrates features of an optical data/power communication unit of an integrated circuit package module;

FIG. 6 illustrates an optical data/power communication unit of an integrated circuit package module, placed alongside and in optical communication with an optical data/power communication unit of a CMOS ASIC;

FIG. 7 illustrates an amplitude spectrum for the bias voltage and the depletion region width modulation (i.e. the output signal) obtained in experimental tests;

FIG. 8 illustrates the experimental setup and a schematic diagram of the circuit used in the experimental tests;

FIG. 9 illustrates a microelectronic chip used in the experimental tests, having nine different large p-n junction structures in a 3×3 arrangement; and

FIG. 10 illustrates the main result of the experimental tests, demonstrating the achievement of light modulation.

In the figures, like elements are indicated by like reference numerals throughout.

### DETAILED DESCRIPTION OF PREFERRED EMBODIMENTS

The present embodiments represent the best ways known to the applicants of putting the invention into practice. However, they are not the only ways in which this can be achieved.

### Initial Overview

Embodiments of the invention provide a method and device for modulating optical energy via structures designed within a CMOS chip using electro-optical effects. Specifically, by electrically modulating the reverse-bias of a p-n junction, the extent of the space-charge region (also known as the depletion region) can be modulated, effectively depleting the highly doped region of free carriers. It has been found that the absorption of light (for example infra-red light) travelling through (or reflected by) a CMOS semiconductor die varies according to charge carrier density. Thus, the extent (e.g. width or depth) of the low charge carrier density depletion region affects the degree of absorption of light passing through (or reflected by) the CMOS semiconductor die. As a consequence, it is possible to modulate the relative absorption of light by electrically modulating the reverse voltage bias of the p-n junction, to thereby vary the extent of the depletion region, and/or vary the charge carrier density in the vicinity of the p-n junction. This is highly advantageous since it provides a way to optically read data out of a CMOS semiconductor device without requiring a light emitter to be integrated into the CMOS device. This therefore allows a standard existing CMOS semiconductor fabrication process to be used.

By using electromagnetic (EM) radiation of photon energy below the band gap of silicon (i.e. light having a corresponding wavelength), the silicon becomes virtually transparent to the incident radiation, thus maximising transmittance. Furthermore, by patterning a metallic film within the insulator area (i.e. interconnect metallisation) on the other side of the p-n junction relative to a light source, electromagnetic (e.g. light) energy incident on the underside of a die can be reflected on incidence with the metallic film and transmitted back through the semiconductor die to its underside for detection (by, for example, a photodetector placed near to the light source).

### Theoretical Basis of the Proposed Mechanism of Electro-Optical Modulation

The basic idea for modulating light through the silicon substrate is by changing the absorption in the free-charge region, by controlling the extent of the space-charge region in a p-n junction [1-8]. In standard CMOS this can be achieved using a parasitic n++/p+ reverse-biased diode to bias a depletion region. The absorption of the light can therefore be changed by growing and shrinking the depletion region, which can be adjusted by applying reverse bias. The following section demonstrates the theoretical feasibility of the proposed approach:

The propagation of an electromagnetic (EM) wave of frequency ω in a conductive medium (of refractive index, n=n_{R}−in₁) can be derived from Maxwell's Equations [9]:

$$\vec{E} ( z , t ) = {\vec{E}}_{0} exp ( - \frac{ω {n}_{I} z}{c} ) exp [ i ω ( t - \frac{{n}_{R} z}{c} ) ] \qquad ( 1 )$$

where E(z,t) is the electric field intensity at the distance z from the surface of the medium where the electric field intensity is E₀, the first exponential term represents the amplitude change and second term the travelling wave with speed c/n_{R}. Here the imaginary part of the refractive index represents the attenuation due to EM wave absorption when penetrating a medium. The intensity of the wave is proportional to the square of the amplitude [9], yielding:

$$I ∝ {\vert E \vert}^{2} ⇒ {I}_{i m} = {I}_{0} \qquad ( 2 )$$

where

$$α = \frac{ω {n}_{I}}{c}$$

is often referred to as the absorption coefficient. If we then consider the reflection of EM waves, for normal incidence (for a wave propagating from medium n₁ to n₂), this is given by:

$$R = \frac{{I}_{r}}{{I}_{i}} = {\vert \frac{{n}_{2} - {n}_{1}}{{n}_{2} + {n}_{1}} \vert}^{2} \qquad ( 3 )$$

### Selection of EM Wavelength

If the optical properties of silicon are studied (see Table 1) it can be seen that for all photon energies under the bandgap of silicon (1.12 eV at room temperature), the imaginary part of the dielectric constant is substantially zero. As a result, silicon is substantially transparent to infra-red (IR) radiation of wavelengths above 1 μm. This ties in well with the fact that commercially available IR emitters (InGaAsP-based) typically have a peak wavelength of around 1550 nm, and therefore suitable IR emitters may readily be obtained.

TABLE 1
Optical properties of (undoped) silicon stating the real and
imaginary parts of the dielectric constant ε for different
photon energies (or wavelengths).

| E(eV) | λ(μm) | εᵣₑₐₗ | ε_{imag} |
|---|---|---|---|
| 0.4 | 3.099 | 11.79279 | 0.00000 |
| 0.8 | 1.550 | 12.11502 | 0.00000 |
| 1.2 | 1.033 | 12.71086 | 0.00136 |
| 1.6 | 0.775 | 13.68177 | 0.03714 |
| 2.0 | 0.620 | 15.19384 | 0.12400 |
| 2.4 | 0.517 | 17.71621 | 0.26331 |

### Nominal Absorption (Zero Bias)

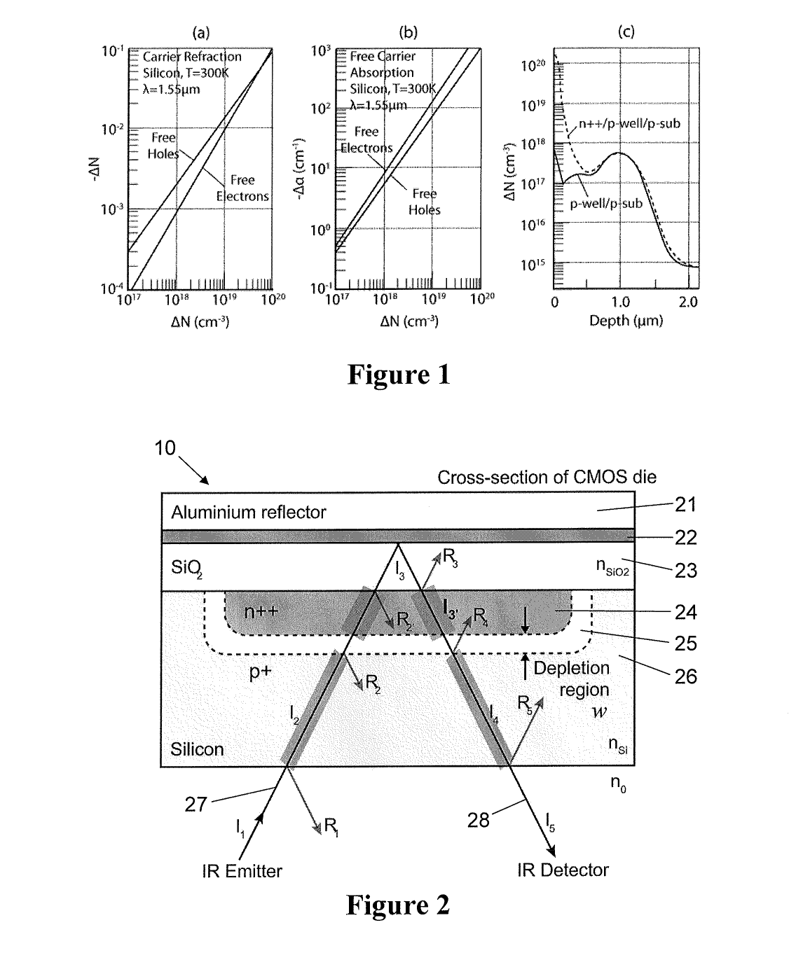

According to FIG. 1(b), for doping concentration N_{D}=10²⁰ cm⁻³ (λ=1.55 μm), α=2·10³ cm⁻¹, and assuming a typical n++/p+ junction depth of 200 nm, the absorption can be calculated from equation (2) above to be approximately 4%. Furthermore, if the IR radiation is reflected off a metal film within an interconnect stack, it will be absorbed again on the return path through the substrate. The total absorbance (with zero bias) will therefore be: [1−(1−0.04)²]=7.84%. Thus, employing a reflective path for the light (rather than a “through” or “transmissive” path) provides the advantage that the absorption effect is doubled.

### Absorption in Doped Silicon

Subsequently, if the free carrier refraction and absorption in doped silicon (as shown in FIGS. 1(a) and 1(b)) are considered, it can be seen how the optical properties of silicon are significantly altered when introducing impurities within the silicon lattice (also referred to as doping). This is because the density of free charge carriers is increased by doping. (As those skilled in the art will appreciate, free charge carriers are those charge carriers such as electrons or holes, which are not bound to the crystal lattice and are therefore able to move.) Since charge effectively changes the refractive index, by increasing the density of free charge carriers the refractive index of silicon is changed. FIG. 1(c) shows a doping profile of a typical CMOS technology. It can be seen from FIG. 1 plots (c) and (b) that typical doping levels are sufficiently high (10¹⁸-10²⁰ cm⁻³) to result in free carrier concentrations which are sufficient to cause moderate absorption of light (of the order of 10¹ to 10³ cm⁻¹).

### Reflectance Losses

FIG. 2 illustrates a cross-section of a CMOS device 10 according to an embodiment of the invention. An incident light beam 27 passes into the device, and is reflected at the interface of a metallized layer 22, resulting in a reflected light beam 28. Secondary reflections R₁, R₂, R_{2′}, R₃, R₄ and R₅ occur at each of the various interfaces between layers, with each secondary reflection comprising a fraction of the incident beam 27. These secondary reflections consequently lead to an overall loss in intensity of the output reflected light beam 28, but to varying degree and also depending whether multiple reflections are not taken into account. If the context of the optical path is considered, the losses due to reflectance can be calculated from equation (3). For the various interfaces, this gives the following values for the secondary reflections: R₁=R₅=30%, R₂=R₄=0.02%, R_{2′}=R₃=10%. As can be expected, the main losses are from the air/silicon boundary (30%) and to a lesser extent between the silicon/silicon-dioxide (10%). Note that R_{2′} reflection does not represent a loss and this reflected wave could interfere with the main reflected beam in the n++ layer (I_{3′}) if the light is coherent. However this effect does not affect the overall modulation process since it will produce a stable correction to the amplitude I_{3′}. If the total losses due to reflectance are then calculated and added to the loss due to the light absorption, the transmitted intensity of the reflected light beam 28 is found to be approximately between 40% and 50% of the intensity of the incident light beam 27 (depending on the incident angle of the light beam 27). This is within acceptable limits for the purpose of sensing a modulation in light intensity (e.g. using an adjacent photodetector). Reflectance losses can be considered constant (assuming both the emitter and detector are static), and if greater intensity of the reflected light beam is required, then this can be achieved by boosting the intensity of the incident light beam 28.

### Modulated Absorption (Biased)

To calculate the change in absorbance when applying a bias V to the junction, the dependence of the width w of the depletion region 25 on bias is given by [10]:

$$w = {x}_{n} + {x}_{p} = \sqrt{\frac{2 {ɛ}_{Si} ( {V}_{bi} - V )}{q} ( \frac{1}{{N}_{D}} + \frac{1}{{N}_{A}} )} \qquad ( 4 )$$

where xₙ (xₚ) and N_{D} (N_{P}) are the depletion layer width and the doping concentrations of the n(p) side, respectively, ∈_{Si} is the Si dielectric constant, q is the electron charge and V_{bi} is the built-in potential.

Therefore, for a (reverse) bias of V=−5V, the increase of depletion width (from zero bias conditions with built-in voltage) is: Δw=(Δxₚ+Δxₙ)=4.4 nm, for doping concentrations N_{A}=N_{D}=10²⁰ cm⁻³. The percentage modulation in transmitted intensity can then be calculated by assuming the depth of the doped region has been reduced, due to carrier depletion. Calculated values (Iₒᵤₜ≡I₅) are shown in Table 2, for several doping concentrations.

TABLE 2
Calculated values for change in transmitted light intensity ΔIₒᵤₜ/Iₒᵤₜ
due to a reverse bias voltage modulation of −5 V, for light wavelength

| N_{D} [cm⁻³] | 10²⁰ | 10²⁰ | 10¹⁹ |
|---|---|---|---|
| N_{A} [cm⁻³] | 10²⁰ | 10¹⁹ | 10¹⁹ |
| ΔIₒᵤₜ/Iₒᵤₜ | 0.23% | 0.06% | 0.025% |

λ=1.55 μm.

It should be noted that the values given in Table 2 will double as the wavelength increases by the square root of 2 (i.e. they will be double for a wavelength λ=2.2 μm). Hence the use of a longer wavelength emitter (LED, laser or laser-diode) will significantly enhance the effect.

### Example Practical Implementations

FIG. 2 shows a practical embodiment of a semiconductor device 10 according to the invention and which, in operation, makes use of the effect described above. A typical CMOS die construction resulting from a typical CMOS semiconductor fabrication process is shown. A substrate 26, for example of silicon, is doped to form a p-type semiconductor. Into the substrate, a suitable dopant element is typically diffused to form an n-type doped region 24. Alternatively and preferably for this application, a p+ well is first created in the p-type substrate. A depletion region 25 exists at the interface between the p-type substrate/well 26 and the n-type doped region 24.

The depletion region 25 is so named because the density of free charge carriers within it is relatively low. The p-type substrate/well 26 and n-type doped region 24 are sealed with a dielectric insulator 23 (for example silicon dioxide, SiO₂). In the embodiment illustrated, a metallisation layer 22 (for example aluminium) is disposed on the dielectric insulator 23, and an encapsulation layer 21 (for example SiO₂) is disposed on the metallisation layer 22.

In use, a light beam 27 from a light source such as an LED, laser or laser-diode (preferably of constant intensity), or from the tip of an optical fibre coupled to an LED, laser or laser-diode, is arranged incident on the p-type silicon substrate (and p+ well) 26, so as to pass through the substrate (and p+ well) 26, through the depletion region 25, through the n-type doped region 24, and through the dielectric insulator 23. In order to pass through the silicon material, the incident light beam 27 is infra-red. For example, the incident light beam 27 may be generated by an infra-red emitter located adjacent to the CMOS die.

The incident light beam 27 is reflected by the metallized layer 22, resulting in a reflected light beam 28. The reflected light beam 28 travels back in the reflected direction through the dielectric insulator 23, the n-type doped region 24, the depletion region 25, and the p-type silicon well and substrate 26, before exiting the die as an output light beam.

Although the illustrated embodiment operates with a reflected light path, in alternative embodiments the light beam 27 may be arranged to pass through the device, rather than being reflected (i.e. such that the output light beam continues in substantially the same direction as the incident light beam).

As discussed above, the depletion region 25 contains relatively few free charge carriers. Since absorption of light is affected by free charge carrier density, and the extent of the depletion region 25 can be controlled by modulating the reverse voltage bias on the p-n junction formed at the depletion region 25, by varying the reverse voltage bias on the p-n junction, the extent of the depletion region 25 can be varied (by virtue of the electrical field resulting from the voltage) and thereby the degree of absorption of the light beam can be varied. Thus, the intensity of the output light beam 28 is optically modulated, by electrically modulating the bias voltage applied to the p-n junction. The intensity of the output light beam 28 thereby carries information representative of the bias voltage applied to the p-n junction. This allows data in (or supplied to) the semiconductor device 10 to be read out of the device optically, requiring no physical connections such as electrical wire bonds.

The principle described above is especially useful when used in conjunction with an Application Specific Integrated Circuit (ASIC) based around a CMOS process, due to the current unavailability of emitting devices in CMOS processes. However, it is envisaged that the principle will operate equally well in any semiconductor process, which employs semiconductor devices which operate using a depletion region (for example, NMOS or PMOS). Moreover, although ASICs are referred to throughout this work, the principle is equally well suited to operation in conjunction with other types of integrated circuits, and to discrete semiconductor devices.

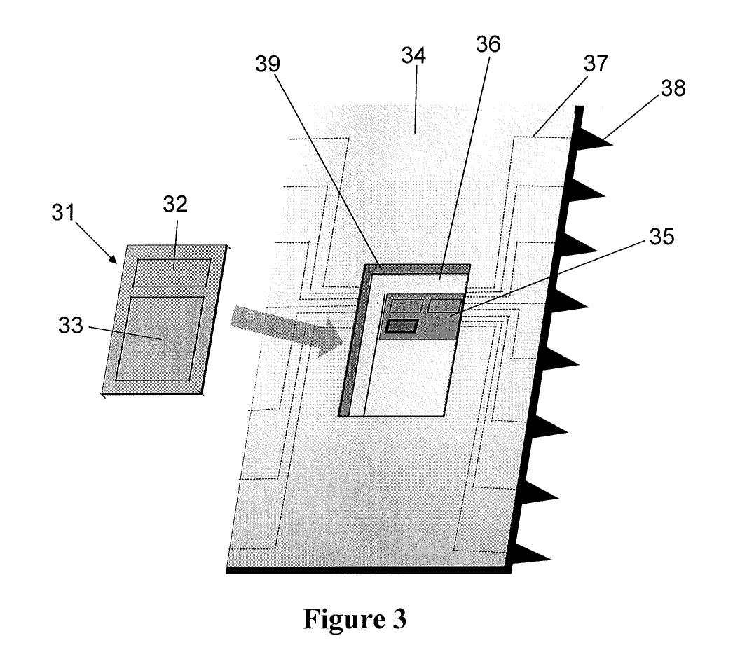

FIG. 3 illustrates an optical chip package interface concept, according to another embodiment of the invention, which can be used either alone or in combination with the embodiment described with reference to FIG. 2. The example optical chip package illustrated in FIG. 3 is a commonly used 16-pin Dual In-Line Package (DIP) form-factor, but the concept applies equally to other chip package form factors (e.g. SOIC, PLCC, PGA, BGA, etc).

FIG. 3 shows an Application Specific Integrated Circuit (ASIC) 31, which is implemented in a standard CMOS technology, and incorporates a structure such as that shown in FIG. 2. The ASIC 31 is connected to the package module 34 via non-galvanic means, i.e. optically. The communication method is by an optical data/power connection (electrically and magnetically contactless), instead of by a typical electrical/magnetic connection (e.g. by bond-wiring the chip to the package).

In this embodiment, the ASIC data/power communication unit 32 within the CMOS ASIC 31 design is realised using standard integrated components and features, such as those available in commercial CMOS technology process device libraries. The ASIC data/power communication unit therefore can be supplied via an IP core library, for example, in a similar fashion to digital logic or I/O libraries. The remaining area of the ASIC 31 is available for use in the design of a custom ASIC core 33, which is typically tailored to the specific application for which the ASIC is designed (for example the ASIC core 33 might contain a microprocessor design and/or memory).

The CMOS die sits in a package recess 39, within the package module 34, and makes physical contact with a step 36, which can be metallized to connect the substrate of the ASIC 31 to a ground pin (if an electrical/galvanic ground reference is needed). Embedded within the package, underneath the recess, is a package data/power communication unit 35. The package data/power communication unit 35 is connected to the packaging pins 38 via connection wires 37.

The data/power communication units of the ASIC 31 and of the package 34 are able to communicate optically when the ASIC 31 is located in the recess 39 of the package 34, by virtue of corresponding, adjacent optical components of each unit. Optical (rather than electrical) connection between the ASIC data/power communication unit 32 and the package data/power communication unit 35 has the result that previously used physical bond pads and I/O ESD protection circuitry are not required in the ASIC core. This can be advantageous since it can save space around the periphery of the ASIC core 33, and can also result in an increase in output connection speed, due to the lack of a need for the previously required serial chain of output buffers or ESD protection circuitry (therefore capacitance and propagation delay can be reduced).

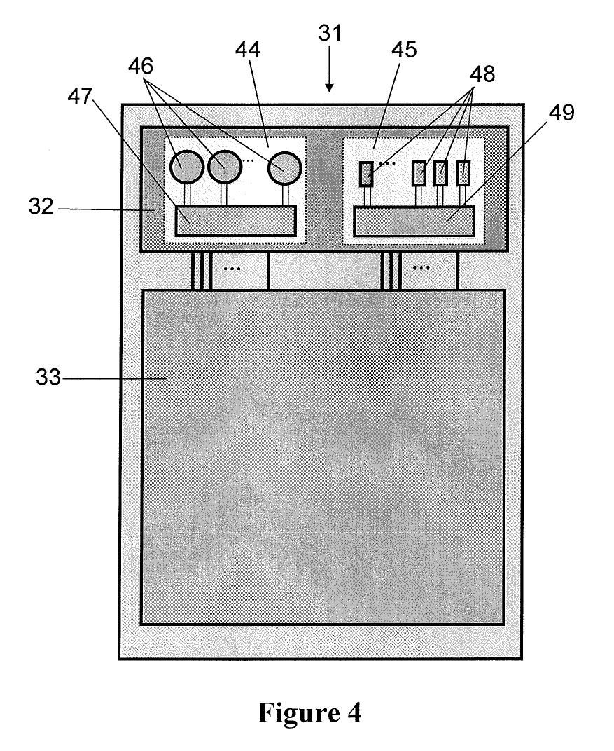

FIG. 4 illustrates, by way of a generic floorplan, the features comprised in a CMOS ASIC 31 design according to this and other embodiments. The ASIC 31 comprises an ASIC core 33 and an ASIC data/power communication unit 32. The ASIC core 33 contains the user-customised logic for performing the application specific function of the ASIC. The ASIC data/power communication unit 32 comprises the components dedicated to the optical interface function. The core 33 and communication unit 32 are arranged as follows. The ASIC core 33 is connected internally to the ASIC data/power communication unit 32 by paths arranged to carry input data and power from the ASIC data/power communication unit 32 to the ASIC core 33, and by paths arranged to carry output data from the ASIC core 33 to the ASIC data/power communication unit 32.

The ASIC data/power communication unit 32 comprises a data output section 44 and an optional input (i.e. power and data input) section 45, and is suitable for provision as a standard semiconductor fabrication process library component for incorporation into ASICs 31 by an ASIC designer.

The data output section 44 comprises at least one p-n junction (or composite multi-junction) structure 46 of the form 10 shown in FIG. 2 and as described above. Each p-n junction (or composite multi-junction) structure 46 corresponds to a part of the output protocol processing circuitry 47. The output protocol processing circuitry 47 receives output signals from the ASIC core 33 and is arranged to process each output signal using a suitable commonly used protocol (example protocol processing includes amplitude modulating the p-n junction bias according to the output signal, frequency modulation, phase modulation, or a combination of those, optionally including error detection and/or redundancy encoding operations) and to apply a reverse voltage bias to the p-n junction structure 46 in response to the output signal.

The optional data input section 45 consists of one (or more) photodiodes 48 with corresponding input data/power recovery circuitry 49, arranged to produce one or more “input signals” which are fed into the ASIC core 33 as inputs to it. In some embodiments, if non-galvanic communication is not required, then only data output from the ASIC core 33 may be transmitted optically, and input data may be supplied to the ASIC core 33 by other means, such as by standard electrical means, or as a chemical or some other sensory input.

In use, the ASIC data/power communication unit 32 communicates with the corresponding unit in the chip package module 34 optically, and consequently data can be interrogated and read out of the ASIC 31 by optical means, in an comparable manner to data read optically from a Compact Disc. This is achieved without the need to integrate an emitting device into the CMOS ASIC 31, which would otherwise require additional and/or modified processing steps and/or materials, and the complete re-characterisation of many process parameters.

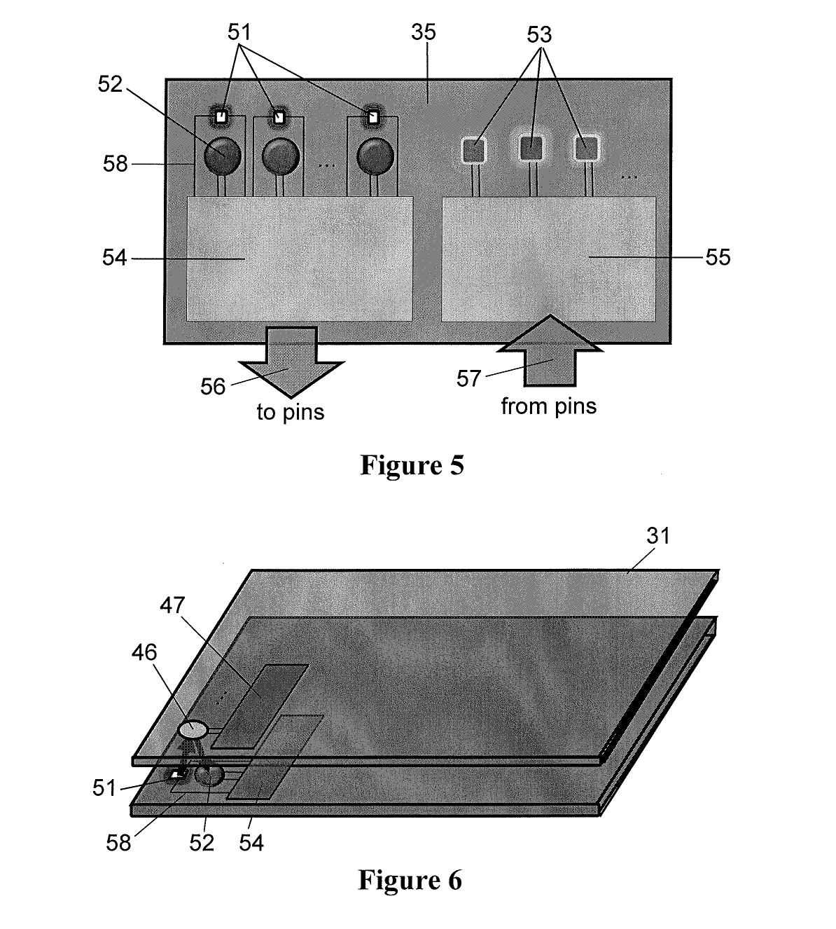

FIG. 5 illustrates the data/power communication unit 35 of the package 34. Data output from the ASIC 31 is accommodated by the following features of the package data/power communication unit 35. The package data/power communication unit 35 (which is incorporated in the package module 34 as shown in FIG. 3) comprises one or more so-called “interrogation light emitters” 51 which are light emitters (such as LEDs, lasers or laser-diodes) arranged to emit light of a substantially constant intensity suitable for interrogation of the biasing state of an adjacent p-n junction structure 46 of an ASIC 31 according to FIG. 4, in the way described above, for the purpose of detecting the biasing state of that p-n junction structure 46.

Each interrogation light emitter 51 is connected to a detector circuit 54. Also connected to the detector circuit 54 is a corresponding photodetector 52 (e.g. an infra-red photodetector). As illustrated in FIG. 5, each interrogation light emitter 51 may have a corresponding photodetector 52 (i.e. the number of interrogation light emitters 51 is the same as the number of photodetectors 52).

In use, the one or more interrogation light emitters 51 are driven via interconnections 58 by the detector circuit 54, so as to cause the emitters 51 to emit light beams 27. By virtue of the package data/power communication unit 35 being arranged adjacent to the ASIC data/power communication unit 32 (see FIG. 6) the light beams 27 fall incident on the corresponding p-n junction structure 46 of the data output section 44 of the ASIC 31. The reflected output light beam 28 (which is modulated by the free carrier absorption effect described above) is detected by the photodetector 52 associated with the respective p-n junction structure 46 of the ASIC 31. The detector circuit 54 associated with the photodetector 52 converts the signal from each photodetector 52 to an output data signal 56 that drives a package pin 38.

Data input to the ASIC core 33 is optionally enabled by the following features. One or more transmitting light emitters 53 of the package data/power communication unit 35 may be connected to input circuitry 55 which is connected to one or more package pins 38 by interconnects 37. Each package pin 38 corresponding to an input signal corresponds to at least one transmitting light emitter 53. In use, each transmitting light emitter 53 is driven by the input circuitry 55 in response to an input signal applied at the package pin 38. The input circuitry 55 modulates current to each transmitting light emitter 53 in accordance with each corresponding input data signal 57, thereby modulating the intensity of light emitted by each transmitting light emitter 53 and thereby transmitting input data to the ASIC 31 by sending light beams to the underside of the optional input section 45 of the data/power communication unit 32 of the (CMOS) ASIC chip 31. The photodiodes 48 of the data input section 45 of the ASIC data/power communication unit 32 receive this light and output a charge or current which is in turn processed by the input data/power recovery circuit 49 and fed to the ASIC core 33 as an input. Optionally, power can also be transmitted from the package data/power communication unit in a similar wireless manner, for example by using high power transmitting light emitters 53 in the package data/power communication unit 35 and high power handling photodiodes 48 or solar cells in the data input section 45 of the ASIC data/power communication unit 32.

In some embodiments, the light emitters 51 and 53 may be provided with light focusing optics, for example microlenses (not shown).

FIG. 6 shows an ASIC 31 having output protocol processing circuitry 47 and associated p-n junction structures 46 (which are part of the ASIC data/power communication unit 32), arranged adjacent to a package data/power communication unit 35. The figure illustrates the components in operation, communicating data from the ASIC 31 to the package data/power communication unit 35 as follows.

In operation, the ASIC 31 is interrogated optically in order to obtain output data from it. An interrogation light emitter 51, embedded within the substrate of the package data/power communication unit 35, is used for the interrogation. The interrogation light emitter 51 illuminates the underside of the data output section 44 (not shown in FIG. 6) of the ASIC 31 with an incident light beam 27 as shown in FIG. 2. At least a portion of this incident light beam 27 falls upon the area of the ASIC 31 which corresponds to a p-n junction structure 46, as shown in FIG. 6. The output protocol processing circuitry 47 of the ASIC 31 receives output data from the ASIC core 33 and modulates the voltage bias on the p-n junction structure 46 accordingly, thereby encoding the output data. The electro-optical effect described above with reference to FIG. 2 (based on free-carrier absorption) modulates the absorption of the light passing through the p-n junction structure 46. A metallic structure such as a metallized layer 22 embedded within the ASIC 31 (for example, an aluminium layer 22 deposited on the dielectric layer 23 as shown in FIG. 2) acts as a mirror, reflecting the modulated light as a reflected light beam 28. The reflected light beam 28 (which has been intensity-modulated with the output data) falls on the photodetector 52 embedded within the package data/power communication unit 35. The photodetector 52 produces an output signal, which is related to the amount of light falling on it. The detector circuit 54 recovers and extracts output data from the output signal received from the photodetector 52 and drives package pins 38 accordingly. The data output pins of the package module 34 thereby correspond to the output data from the ASIC core 33. Thus, output data can be optically read from the ASIC 31.

### Summary of Some of the Advantages Provided by Embodiments of the Invention

The associated benefits of using a standard CMOS semiconductor fabrication process to fabricate an optically connected ASIC device (as provided for by this invention) include lower cost, greater accessibility to production facilities and lower design effort compared with custom fabrication processes necessary for integrating emitter devices on-chip. Benefits of optically communicating with a semiconductor die (which is enabled by the invention) include: electrical isolation leading to protection from damage due to electrostatic discharge (without the need for hitherto used input and output protection circuitry); isolation from electrical noise leading to increased signal integrity; increased connection reliability resulting from the elimination of welded joints between on-chip bond pads and bond wires; and potentially increased connection speed due to the elimination of the additional capacitance brought about by on-chip bond pads and bond wires. Further benefits include: potentially increased speed due to the elimination of input and output buffer chains; and potentially reduced on-chip area requirements and/or increased chip layout flexibility due to the elimination of the hitherto necessary relatively large on-chip wire bond pads. The top surface of the chip die, now liberated from the protruding bond wires, becomes available for surface sensing, microfluidic integration or any other functional layer.

A package module 34 such as that shown in FIG. 3, incorporating a data/power communication unit 35, would thus enable any CMOS ASIC 31 die incorporating a corresponding data/power communication unit 32 to be packaged into a board-level integrate-able chip package, suitable for mounting on a PCB. By virtue of the present invention, this can be achieved without the need for special skills as previously required, since no wire bonding techniques are necessary.

Thus, to conclude, embodiments of the invention use a parasitic p-n junction in modern CMOS technology to modulate optical (electromagnetic) radiation by adjusting the reverse bias, thus changing the relative absorption. A benefit over traditional silicon photonics (i.e. for optical communication) is that the structures detailed in the present work can be implemented in standard CMOS technology. This is considered to be the first technique capable of achieving optical modulation (electrically-controlled) in standard (i.e. unmodified) CMOS technology. The use of non-galvanic communication is ideally suited for applications requiring electrical isolation, e.g. “lab-on-chip” readouts. This means that CMOS chips can now achieve data/power transfer without any wire bonds.

Although in the present work we have concentrated on modulating EM absorption by controlling the space charge region, other electro-optical effects exist, and in certain situations it may be possible to exploit them in a similar manner to the presently described embodiments. These include the Pockel's Effect (birefringence in an optical medium by electric field), the Franz-Keldysh Effect (change in optical absorption by a semiconductor with electric field) and the Kerr Effect (changing refractive index of a material with electric field). However, the mechanism described in the present work is preferred over these phenomena—either due to their absence in bulk silicon (i.e. for the Pockels Effect), or due to negligible changes given constraints (such as maximum electric field strength) in standard CMOS technologies.

### Experimental Demonstration

The following experimental method and apparatus have been used to demonstrate and measure IR light modulation for free-space communication with an unmodified CMOS chip. This incorporates a phase-lock technique for detecting week signals, by locking-in to the second harmonic.

In terms of signal detection, there are many situations where the mean frequency being detected is known beforehand; and furthermore, that the signal peak(s) in frequency space is very narrow. In these situations we would ideally like to have the narrowest possible bandwidth over which our detector operates. Simple approaches such as a low-pass RC filter can give us bandwidths of the order of 0.02 Hz, and this may be good enough if the noise power over the bandwidth is significantly lower than our signal power; however, we can apply more sophisticated techniques than filtering to achieve bandwidths with a Q-factor approaching 10⁵. Phase-sensitive detection is one such technique; by modulating the input with a square or sine wave at a frequency much higher than the communication/data signal, we “encode” the desired information at one specific frequency (it is the amplitude variation at this frequency that “carries” the data information). At the detector, the encoded signal and any noise are picked up, amplified, and then passed through a second modulator operating at the same frequency as the first modulator. The second modulation (more often called demodulation) returns the original signal plus the noise randomised at a very high frequency. By taking an appropriate circuit average, the noise is suppressed, and the final output is just the signal itself.

This is the operational principle of the lock-in amplifier. In our experimental demonstration we locked-in to the second harmonic. Although the p-n junction bias voltage (the input signal) is modulated at a frequency f, the light absorption will show higher harmonics in its spectrum. This is important because the fundamental frequency might still be compromised by noise, but the second harmonic might be possible to detect. That is what we achieved in our experiments.

In our experiments, the signal we measured was: light intensity I=I₀*exp(−αL). This is an approximation since α depends on the doping concentration, but we can assume that both the p-type and n-type sides of the p-n junction have the same concentration of dopants. L₀ can be the thickness of the doped layers.

The depletion region width depends on the bias voltage V=V_{DCoffset}+V₀*sin(2πft) as:

w=A*\sqrt{V_{builtin}−V_{DCoffset}−V₀*sin(2πft)} (5)

The free-carrier absorption occurs in the area of the length: L=L₀−w, and hence the output signal is:

I=I₀*exp(−αL)=I₀*exp(−αL₀)*exp(αw)≈Cαw (6)

for small αw.

By substituting equation (5) into equation (6) we obtain an expression for the dependence of the output signal on the bias voltage I=I(V).

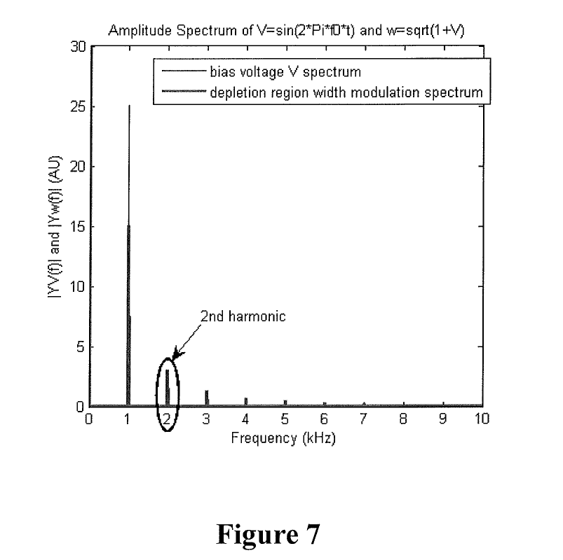

The V_{builtin} is given by the doping concentrations, V_{DCoffset} (<0) is our parameter depending how we want to shift the biasing stimulus, and V₀ (V₀<0) is the amplitude of the voltage bias oscillations. The spectrum of the depletion region width modulation (which is the same as the spectrum of the output signal I) is illustrated in FIG. 7.

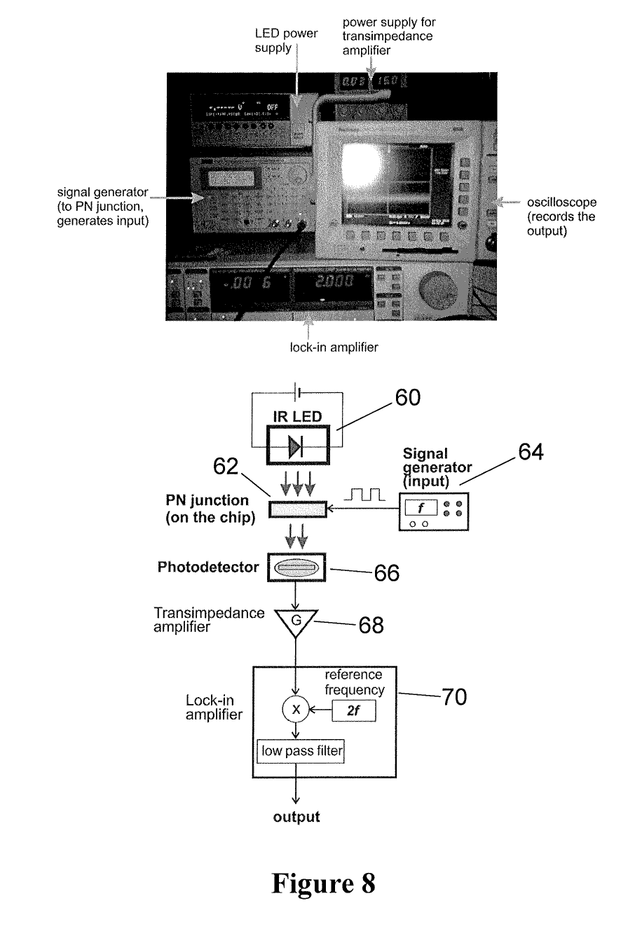

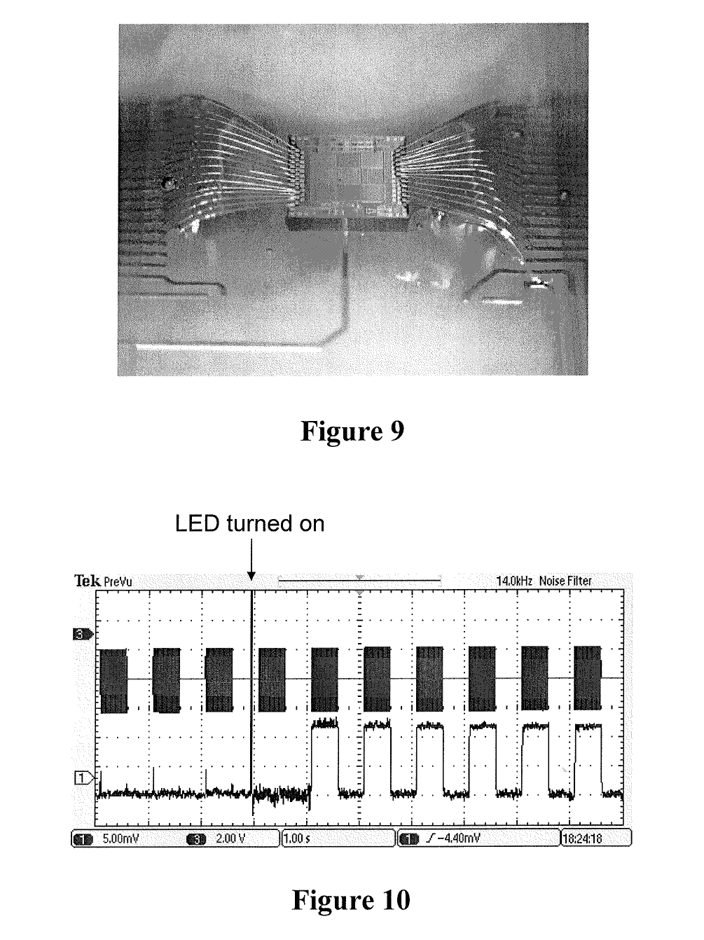

The experimental setup with a description of individual parts is given in FIG. 8. and a picture of the chip under investigation is shown in FIG. 9. As shown in FIG. 8, an infra-red LED 60 was arranged to transmit infra-red light through a p-n junction 62 on the chip. The intensity of the infra-red output light emerging from the p-n junction was detected by a photodetector 66. A signal generator 64 was electrically connected to the p-n junction and used to modulate the depletion width of the p-n junction. The output signal from the photodetector 66 was processed using a transimpedance amplifier 68, and then a lock-in amplifier 70 configured to lock-in to the second harmonic (i.e. a frequency 2f, where f is the carrier frequency of the signal generator 64) and then apply a low pass filter.

FIG. 10 shows the main result of the experimental tests, demonstrating the achievement of modulated output light from the p-n junction 62 in response to an electrical signal applied to the p-n junction by the signal generator 64. In FIG. 10, trace 1 (at the bottom) depicts the optical output signal from the p-n junction 62, measured by the photodetector 66 and then processed by the transimpedance amplifier 68 and lock-in amplifier 70. Trace 3 (at the top) depicts the electrical signal (bias voltage) applied to the p-n junction 62 by the signal generator 64, to modulate the depletion width of the p-n junction.

Trace 1 shows in the left hand part that when the LED light is OFF, then modulation of the depletion width in the p-n junction 62, caused by the bias voltage shown in trace 3, has no effect on the output. Once the LED light is turned ON (switching artifacts show a big narrow spike three units from the beginning of the recording window) then, after a transitional period, the bias voltage applied to the p-n junction 62 in the shape of a square wave (modulated sine wave) by the signal generator 64 is faithfully reproduced on the optical output as detected by the photodetector 66.

The parameters used in this experiment were as follows:

DC offset V_{shift}=−3.15V

### Vₚₚ=6V

f=1 kH
f_{modulation}=1 Hz

It should be noted that V_{shift} was important in order to eradicate signal generator second harmonic interference (pick up on the output). The results were sensitive to the DC offset voltage (V_{shift}). The lock-in to the second harmonic used an integration time of 3 ms.

The LED light source operated with a wavelength of 1550 nm, current 90 mA, voltage 1.28V, and had an optical output of ˜4 mW.

### REFERENCES

[1] R. A. Soref et al., “Electrooptical Effects in Silicon”, IEEE Trans. Quantum Electr., Vol. 23, No. 1, pp. 123-129, 1987.
[2] R. Soref, “Mid-infrared photonics in silicon and germanium”, Nature Photon., Vol. 4, pp. 495-497, 2010.
[3] G. T. Reed et al., “Silicon optical modulators”, Nature Photon., Vol. 4, pp. 518-526, 2010.
[4] C. K. Tang & G. T. Reed, “Highly efficient optical phase modulator in SOI waveguides”, Electron. Lett., Vol. 31, pp. 451-452, 1995
[5] A. Liu et al. “A high-speed silicon optical modulator based on a metal-oxide-semiconductor capacitor”, Nature, Vol. 427, pp. 615-618, 2004.
[6] Q. Xu et al. “Micrometre-scale silicon electro-optic modulator”, Nature Vol. 435, pp. 325-327, 2005.
[7] M. Lipson, “Compact Electro-Optic Modulators on a Silicon Chip”, IEEE J. Sel. Topics Quantum Electron., Vol. 12, pp. 1520-1526, 2006
[8] A. Liu, et al. “40 Gbit/s silicon optical modulator for high-speed applications”. Electron. Lett. Vol. 43, 1196-1197, 2007
[9] R. P. Feynman, et al., “The Feynman Lectures on Physics”, Addison-Wesley, Volume 2, Chapters 32-33, 1964.
[10] S. M. Sze, “Physics of Semiconductor Devices”, Wiley-Interscience, 1981.

1-57. (canceled)

58. A method of optically outputting information from a semiconductor device, the method comprising:
providing a semiconductor device having a semiconducting p-n junction, the p-n junction having a region of reduced free charge carrier density;
applying an electrical signal to modulate the extent of the said region, the electrical signal being representative of the information to be outputted;
arranging incident light to pass through at least part of the said region, such that the light is at least partially absorbed in dependence upon the modulated extent of the said region, thereby producing intensity-modulated output light; and
detecting the intensity of the output light and thereby determining the outputted information.

59. A method as claimed in claim 58, further comprising providing the semiconductor device with a reflective layer positioned such that the incident light is reflected off the reflective layer after having passed through the said region, thus causing the light to pass back through the said region before being outputted.

60. A method as claimed in claim 59, further comprising providing the semiconductor device with an insulating layer between the p-n junction and the reflective layer.

61. A method as claimed in claim 58, wherein the incident light is transmitted through the said region such that the output light continues in substantially the same direction as the incident light.

62. A method as claimed in claim 58, wherein the detecting step further comprises comparing the intensity of the output light with a reference intensity.

63. A method as claimed in claim 62, wherein the reference intensity is derived from the intensity of the incident light.

64. A method as claimed in claim 58, further comprising supplying power wirelessly to the semiconductor device.

65. A method as claimed in claim 58, wherein the electrical signal comprises a carrier frequency, the carrier frequency being amplitude modulated with a data signal.

66. A method as claimed in claim 65, further comprising processing the detected intensity of the output light using a phase-lock technique.

67. A method as claimed in claim 66, wherein the phase-lock technique locks in to a second harmonic 2f, where f is the said carrier frequency.

68. An electro-optical assembly comprising:
a semiconductor device having a semiconducting p-n junction, the p-n junction having a region of reduced free charge carrier density;
electrical means arranged to apply an electrical signal to modulate the extent of the said region, the electrical signal being representative of information to be outputted from the semiconductor device;
a light source arranged to provide incident light to pass through at least part of the said region, such that the light is at least partially absorbed in dependence upon the modulated extent of the said region, thereby producing intensity-modulated output light; and
a detector arranged to detect the intensity of the output light and thereby determine the outputted information.

69. An electro-optical assembly as claimed in claim 68, further comprising a reflective layer positioned such that the incident light is reflected off the reflective layer after having passed through the said region, thus causing the light to pass back through the said region before being outputted.

70. An electro-optical assembly as claimed in claim 69, further comprising an insulating layer between the p-n junction and the reflective layer.

71. An electro-optical assembly as claimed in claim 68, wherein the incident light is transmitted through the said region such that the output light continues in substantially the same direction as the incident light.

72. An electro-optical assembly as claimed in claim 68, wherein the detector is configured to compare the intensity of the output light with a reference intensity.

73. An electro-optical assembly as claimed in claim 72, wherein the reference intensity is derived from the intensity of the incident light.

74. An electro-optical assembly as claimed in claim 68, wherein the semiconductor device further comprises means for receiving power wirelessly.

75. An electro-optical assembly as claimed in claim 68, wherein the electrical signal comprises a carrier frequency, the carrier frequency being amplitude modulated with a data signal.

76. An electro-optical assembly as claimed in claim 75, wherein the detected intensity of the output light is processed using a phase-lock amplifier.

77. An electro-optical assembly as claimed in claim 76, wherein the phase-lock amplifier is configured to lock in to a second harmonic 2f, where f is the said carrier frequency.

78. An integrated circuit chip comprising:
a semiconductor device having a semiconducting p-n junction, the p-n junction having a region of reduced free charge carrier density; and
electrical means operable in use to apply an electrical signal to modulate the extent of the said region, the electrical signal being representative of information to be outputted from the semiconductor device;
wherein, in use, the said region is accessible by incident light, such that the incident light is able to pass through at least part of the said region, the light being at least partially absorbed in dependence upon the modulated extent of the said region, thereby producing intensity-modulated output light.

79. An integrated circuit chip as claimed in claim 78, further comprising a reflective layer positioned such that, in use, the incident light is reflected off the reflective layer after having passed through the said region, thus causing the light to pass back through the said region before being outputted.

80. An integrated circuit chip as claimed in claim 79, further comprising an insulating layer between the p-n junction and the reflective layer.

81. An integrated circuit chip as claimed in claim 78, further comprising means for receiving power wirelessly.
